(19) United States
(12) Patent Application Publication
(10) Pub. No.: US 2009/0153628 A1
(43) Pub. Date: Jun. 18, 2009

(54) LIQUID SUPPLYING DEVICE AND LIQUID EJECTING APPARATUS

(75) Inventor: Hideya Yokouchi, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/337,233

(22) Filed: Dec. 17, 2008

(30) Foreign Application Priority Data
Dec. 18, 2007 (JP) 2007-326238
Aug. 29, 2008 (JP) 2008-222049

(51) Int. Cl. B41J 2/175

(52) U.S. Cl. 347/85

(57) ABSTRACT

A liquid supplying device includes a liquid supplying flow path that supplies a liquid from an upstream side as a liquid supplying source side toward a downstream side on which the liquid is consumed, a pump that is driven for changing the volume of a pump chamber that is a part of the liquid supplying flow path, and a flow velocity reducing unit that reduces the flow velocity of the liquid passing through the liquid supplying flow path on the upstream side of the pump chamber by changing flow path resistance of the liquid supplying flow path in accordance with the speed of change of the volume of the pump chamber, in a case where the pump is driven for a suction operation that increases the volume of the pump chamber.

### BACKGROUND

The entire disclosure of Japanese Patent Application No. 2007-326238, filed Dec. 18, 2007 and Japanese Patent Application No. 2008-222049, filed Aug. 29, 2008, are expressly incorporated herein by reference.

1. Technical Field

The present invention relates to a liquid supplying device and a liquid ejecting apparatus that supply a liquid from the upstream side as the liquid supplying source side toward the downstream side on which the liquid is consumed.

2. Related Art

Generally, as liquid ejecting apparatuses that eject liquids onto targets, ink jet printers (hereinafter, referred to as printers) have been widely known. The printers perform a print operation for a recording medium as a target by ejecting ink (liquid) supplied to a record head (a liquid ejecting head) from a nozzle formed on the record head. Among the above-described printers, recently, printers having a pump that is driven for a pumping operation for pressing and supplying ink from an ink cartridge side to the record head side in the middle of an ink flowing path (a liquid supplying path) that connects between the ink cartridge (a liquid supplying source) and the record head have been proposed. In the printers, when a pump chamber is in the negative-pressure state in accompaniment with driving the pump for a suction operation, ink is sucked into the pump chamber from the ink cartridge, and the ink is supplied to the record head side in a state in which the ink is pressed state in accompaniment with driving the pump for an ejection operation.

However, in the printers, when the pump chamber is in the negative-pressure state in accompaniment with driving the pump for the suction operation, ink rapidly flows into the pump chamber that is in the negative-pressure state from the upstream side. In other words, ink is sucked into the inside of the ink flowing path from the ink cartridge at a high speed and flows into the inside of the pump chamber. Accordingly, when ink is sucked from the ink cartridge at a high flow velocity, air may be sucked into the ink flowing path together with the ink so as to generate air bubbles in the ink. Then, when the ink in which the air bubbles are mixed is supplied to the downstream side in accompaniment with driving the pump for an ejection operation, the air bubbles may grow in the ink flowing path so as to block the flow of the ink or generate nozzle clogging of the record head. Thus, in order to suppress suction of air, a printer in which the flow velocity of the ink is reduced by disposing a flow path resistor in the middle of the ink flowing path located between the pump and the ink cartridge has been proposed (for example, see JP-A-2005-81744).

In the printer disclosed in JP-A-2005-81744, a filter that has a main function of eliminating foreign materials is disposed in the middle of the ink flowing path. In addition, the filter also serves as a flow path resistor for reducing the speed of ink passing the filter in a case where ink passes through the filter from the upstream side to the downstream side in accompaniment with driving a negative-pressure pump disposed on the downstream side. In other words, the filter has a function for suppressing suction of air bubbles together with a function for eliminating foreign materials.

When ink is rapidly sucked from the ink cartridge, the air is infused as infusion of external air from a connection part (in particular, an insertion part of an ink supplying needle) of the ink cartridge and the ink flowing path occurs or suction of air inside the ink cartridge opened to the air through an air communication hole together with ink occurs in a case where the remaining amount of ink is small. However, when the pump is driven gently for a suction operation and the flow velocity of ink flowing inside the ink flowing path from the upstream side to the downstream side is low, ink is slowly sucked from the ink cartridge. Accordingly, in such a case, the infusion of air into the ink does not cause any serious problem described above.

In the printer disclosed in JP-A-2005-81744, the filter is fixedly disposed in the middle of the ink flowing path. Accordingly, even when the ink is sucked slowly, the filter also serves as the flow path resistor in the same manner. Thereby, the driving efficiency of the pump decreases.

### SUMMARY

An advantage of some aspects of the invention is that it provides a liquid supplying device capable of suppressing infusion of air into the inside of the liquid supplying flow path in a case where a pump is driven for a suction operation in which a liquid is sucked into the liquid supplying flow path from the liquid supplying source and maintaining the driving efficiency of the pump in an excellent state and a liquid ejecting apparatus having the above-described liquid supplying device.

According to a first aspect of the invention, there is provided a liquid supplying device including: a liquid supplying flow path that supplies a liquid from an upstream side as a liquid supplying source side toward a downstream side on which the liquid is consumed; a pump that is driven for changing the volume of a pump chamber that is a part of the liquid supplying flow path; and a flow velocity reducing unit that reduces the flow velocity of the liquid passing through the liquid supplying flow path on the upstream side of the pump chamber by changing flow path resistance of the liquid supplying flow path in accordance with the speed of change of the volume of the pump chamber, in a case where the pump is driven for a suction operation that increases the volume of the pump chamber.

According to the above-described liquid supplying device, when the pump is driven for the suction operation, the pump chamber changes in the direction for increasing the volume thereof, and accordingly, negative pressure is generated inside the liquid supplying flow path disposed on the upstream side of the pump chamber. Accordingly, the liquid is sucked into the inside of the pump chamber from the upstream side that becomes the liquid supplying source side through the liquid supplying flow path. In such a case, when the speed of change of the volume of the pump chamber is high, the liquid is sucked from the liquid supplying source through the inside of the liquid supplying flow path at a high flow velocity. However, since the flow velocity reducing unit changes the flow path resistance of the liquid supplying flow path in accordance with the speed of change of the volume of the pump chamber, the flow velocity of the liquid decreases. In other words, when the flow velocity of the liquid at a time when the liquid is sucked into the inside of the liquid supplying flow path from the liquid supplying source is too high, the flow path resistance increases, and accordingly, the flow velocity of the liquid is reduced such that infusion of air can be suppressed. On the other hand, when the speed of change of the volume of the pump chamber is slow, the flow path resistance does not increases that much, and thus, the flow velocity is not reduced that much. Accordingly, infusion of air from the liquid supplying source into the inside of the liquid supplying flow path for a case where the pump is driven for the suction operation can be suppressed, and the driving efficiency of the pump can be maintained in an excellent state.

According to a second aspect of the invention, there is provided a liquid supplying device including: a liquid supplying flow path that supplies a liquid from an upstream side as a liquid supplying source side toward a downstream side on which the liquid is consumed; a pump that is driven for changing the volume of a pump chamber that is a part of the liquid supplying flow path; and a flow velocity reducing unit that reduces the flow velocity of the liquid passing through the liquid supplying flow path to be a second flow velocity that is lower than a first flow velocity by changing flow path resistance of the liquid supplying flow path which is disposed on the upstream side of the pump chamber and the liquid can pass through at the first flow path in accordance with the speed of change of the volume of the pump chamber, in a case where the pump is driven for a suction operation that increases the volume of the pump chamber.

According to the above-described liquid supplying device, when the pump is driven for the suction operation, the pump chamber changes in the direction for increasing the volume thereof, and accordingly, negative pressure is generated inside the liquid supplying flow path disposed on the upstream side of the pump chamber. Accordingly, the liquid is sucked into the inside of the pump chamber from the upstream side that becomes the liquid supplying source side through the liquid supplying flow path. In such a case, when the speed of change of the volume of the pump chamber is high, the liquid is sucked from the liquid supplying source through the inside of the liquid supplying flow path at a first flow velocity. However, since the flow velocity reducing unit changes the flow path resistance of the liquid supplying flow path in accordance with the speed of change of the volume of the pump chamber, the flow velocity of the liquid decreases to a second flow velocity that is lower than the first flow velocity. In other words, when the flow velocity of the liquid at a time when the liquid is sucked into the inside of the liquid supplying flow path from the liquid supplying source is too high, the flow path resistance increases, and accordingly, the flow velocity of the liquid is reduced to the second flow velocity at which infusion of air can be suppressed. On the other hand, when the speed of change of the volume of the pump chamber is slow, the flow path resistance does not increases that much. In other words, since the liquid is sucked at a flow velocity close to the second flow velocity, the liquid passes at the second flow velocity without increasing the flow path resistance that much. Accordingly, infusion of air from the liquid supplying source into the inside of the liquid supplying flow path for a case where the pump is driven for the suction operation can be suppressed, and the driving efficiency of the pump can be maintained in an excellent state.

In the above-described liquid supplying device, the flow velocity reducing unit may have a high response speed of changing the flow path resistance of the liquid supplying flow path for a case where the speed of change of the volume of the pump chamber is high, compared to a case where the speed of change of the volume of the pump chamber is low.

In such a case, as the speed of change of the volume of the pump chamber increases, that is, as the flow velocity of the liquid sucked into the liquid supplying flow path from the liquid supplying source is to increase originally, the response speed of the flow velocity reducing unit for changing the flow path resistance of the liquid supplying flow path increases. Accordingly, for a case where the flow velocity of the liquid sucked into the inside of the liquid supplying flow path from the liquid supplying source is to be high originally, the flow velocity decreases rapidly by the flow velocity reducing unit. Therefore, infusion of air can be suppressed effectively.

In the above-described liquid supplying device, the flow velocity reducing unit may include a displacement member that is displaced so as to change the flow path resistance of the liquid supplying flow path.

In such a case, by displacing the displacement member of the flow velocity reducing unit in the direction for increasing the flow path resistance of the liquid supplying flow path, the flow velocity of the liquid can be reduced by using the increased flow path resistance in a simple manner.

According to a third aspect of the invention, there is provided a liquid supplying device including: a liquid supplying flow path that supplies a liquid from an upstream side as a liquid supplying source side toward a downstream side on which the liquid is consumed; a pump that is driven for changing the volume of a pump chamber that is a part of the liquid supplying flow path; and a flow resistance changing unit that changes flow path resistance of the liquid supplying flow path on the upstream side of the pump chamber in accordance with the speed of change of the volume of the pump chamber in a case where the pump is driven for a suction operation that increases the volume of the pump chamber.

According to the above-described liquid supplying device, when the pump is driven for the suction operation, the pump chamber changes in the direction for increasing the volume thereof, and accordingly, negative pressure is generated inside the liquid supplying flow path disposed on the upstream side of the pump chamber. Accordingly, the liquid is sucked into the inside of the pump chamber from the upstream side that becomes the liquid supplying source side through the liquid supplying flow path. In such a case, for example, when the flow path resistance is changed to increase by using the flow path resistance changing unit in a case where the speed of change of the volume of the pump chamber is high, the flow velocity of the liquid passing through the inside of the liquid supplying flow path is reduced. Accordingly, infusion of air into the inside of the liquid supplying flow path for a case where the pump is driven for the suction operation in which the liquid is sucked into the inside of the liquid supplying flow path from the liquid supplying source can be suppressed. On the other hand, when the speed of change of the volume of the pump chamber is low, the flow path resistance does not increases that much, and accordingly, the flow velocity is not reduced that much. Accordingly, the driving efficiency of the pump can be maintained in an excellent state.

In the above-described liquid supplying device, the flow velocity of the liquid passing through the liquid supplying path of which the flow path resistance is changed by the flow path resistance changing unit may be configured to be lower than that before the change of the flow path resistance by using the flow path resistance changing unit.

In such a case, the flow velocity of the liquid passing through the liquid supplying flow path of which flow path resistance changes is reduced. Accordingly, infusion of air into the inside of the liquid supplying flow path for a case where the pump is driven for the suction operation in which the liquid is sucked into the inside of the liquid supplying flow path from the liquid supplying source can be suppressed.

In the above-described liquid supplying device, the flow path resistance changing unit has a relatively high response speed of changing the flow path resistance of the liquid supplying flow path for a case where the speed of change of the volume of the pump chamber may be configured to be high, compared to a case where the speed of change of the volume of the pump chamber is low.

In such a case, as the speed of change of the volume of the pump chamber increases, that is, as the flow velocity of the liquid sucked into the liquid supplying flow path from the liquid supplying source is to increase originally, the response speed of the flow path resistance changing unit for changing the flow path resistance of the liquid supplying flow path increases. Accordingly, for a case where the flow velocity of the liquid sucked into the inside of the liquid supplying flow path from the liquid supplying source is to be high originally, the flow velocity is reduced rapidly by the flow path resistance changing unit. Therefore, infusion of air can be suppressed effectively.

In the above-described liquid supplying device, the flow path resistance changing unit may be configured to include a displacement member that is displaced so as to change the flow path resistance of the liquid supplying flow path.

In such a case, by displacing the displacement member of the flow path resistance changing unit in the direction for increasing the flow path resistance of the liquid supplying flow path, the flow velocity of the liquid can be reduced by using the increased flow path resistance in a simple manner.

In the above-described liquid supplying device, the displacement member can be displaced to a position located on the upstream side of the pump chamber inside the liquid supplying flow path and may be displaced so as to narrow the inside of the liquid supplying flow path in a case where negative pressure generated in accompaniment with driving the pump for the suction operation is received.

In such a case, when negative pressure is applied to the inside of the liquid supplying flow path disposed on the upstream side of the pump chamber in accompaniment with driving the pump for the suction operation, the displacement member disposed to be displaced inside the liquid supplying flow path is displaced so as to narrow the inside the liquid supplying flow path, and thereby, the flow path resistance increases. Accordingly, the flow path resistance can be changed in accordance with the speed of change of the volume of the pump chamber by using a simple configuration without a complicated configuration.

In the above-described liquid supplying device, the displace member may be configured by a valve body that can be displaced between a close-valve position in which the liquid supplying flow path is closed and an open-valve position in which the liquid supplying flow path is opened, is normally biased toward the close-valve position side at a predetermined biasing force, and is displaced to the open-valve position side in resistance to the biasing force in a case where negative pressure generated in accompanied with driving the pump for the suction operation is received, and a through hole that allows passage of the liquid from the upstream side to the downstream side in a case where the valve body is displaced in the direction from the close-valve position to the open-valve position may be formed in the valve body.

In such a case, when the pump is driven for the suction operation, the displacement member serves as a one-way valve that allows passage of the liquid only from the upstream side to the downstream side. Accordingly, by additionally using the one-way valve as a constituent element of the flow velocity reducing unit, the number of parts can decrease. In addition, the counter flow of the liquid to the liquid supplying source side can be suppressed by using the displacement member in a case where the pump is driven for the ejection operation.

In the above-described liquid supplying device, a throttle forming part that allows passage of the liquid between the upstream side and the downstream side of the displacement member in a case where the displacement member is displaced in the direction for increasing the flow path resistance of the liquid supplying flow path to be in a state in which the liquid supplying path is closed may be disposed in at least one between an outer face of the displacement member and an inner face of the liquid supplying flow path.

In such a case, even when the displacement member is displaced in the direction for increasing the flow path resistance of the liquid supplying flow path to be in a state in which the liquid supplying flow path is closed, the liquid passes through the throttle forming part and flows from the upstream side to the downstream side. In other words, while the flow velocity of the liquid is reduced due to the flow path resistance of the throttle forming part, the flow path is acquired, and accordingly, the liquid can be supplied to the downstream side with infusion of air suppressed.

According to a fourth aspect of the invention, there is provided a liquid ejecting apparatus including: a liquid ejecting head that ejects a liquid; and the above-described liquid supplying device that supplies the liquid to the liquid ejecting head.

According to the above-described liquid ejecting apparatus, the liquid in which the infusion of air is suppressed is supplied from the liquid supplying device. Accordingly, when the liquid is ejected from the liquid ejecting head, occurrence of ejection failure due to clogging or the like can be suppressed.

### BRIEF DESCRIPTION OF THE DRAWINGS

The invention will be described with reference to the accompanying drawings, wherein like numbers reference like elements.

FIG. 1 is a schematic diagram of an ink jet printer according to a first embodiment of the invention.

FIG. 2A is a schematic diagram of a liquid supplying device in a case where a pump is driven for a suction operation according to the first embodiment.

FIG. 2B is a schematic diagram of a liquid supplying device according to the first embodiment in a case where a pump is driven for an ejection operation.

FIG. 3A is a schematic diagram of a liquid supplying device according to the first embodiment in a case where ink is ejected.

FIG. 3B is a schematic diagram of a liquid supplying device according to the first embodiment in a case where ink is ejected and a pump performs a suction operation.

FIG. 4A is a schematic diagram showing the close-valve position of a suction-side valve according to a second embodiment of the invention.

FIG. 4B is a schematic diagram showing the open-valve position of a suction-side valve according to the second embodiment.

FIG. 4C is a planar schematic diagram showing the top dead center point of a suction-side valve according to the second embodiment.

FIG. 5A is a schematic diagram showing a suction-side valve according to a first modified example of the invention.

FIG. 5B is a schematic diagram showing a suction side valve according to the first modified example, viewed in the flow path direction.

FIG. 6 is a schematic diagram showing a suction-side valve according to a second modified example of the invention.

### DESCRIPTION OF EXEMPLARY EMBODIMENTS

### First Embodiment

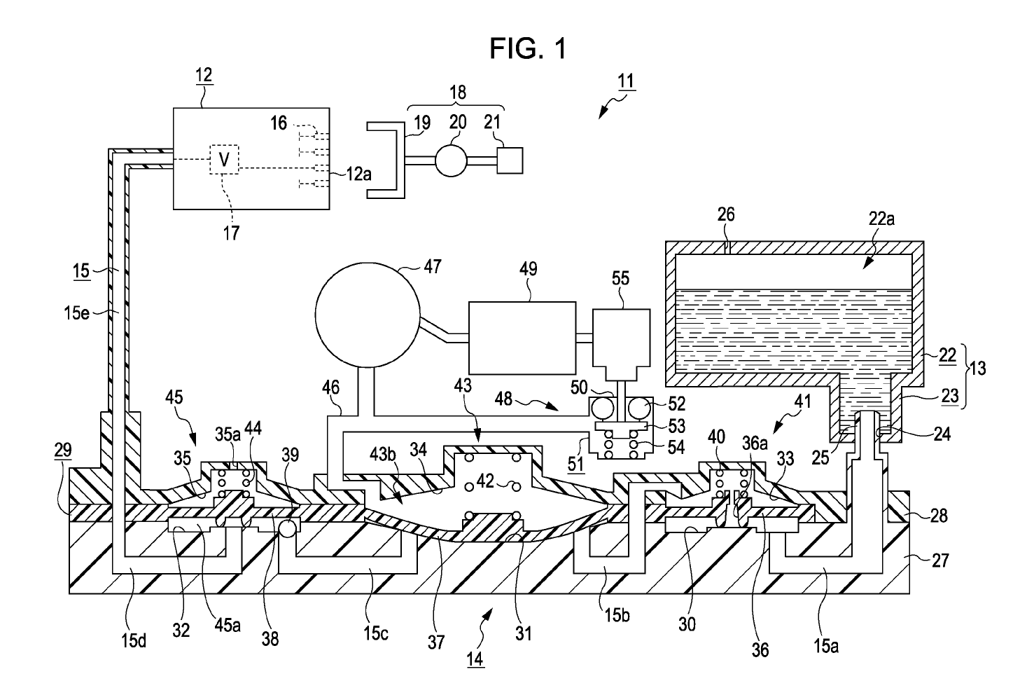

Hereinafter, an ink jet recording apparatus (hereinafter, referred to as a printer) according to a first embodiment of the invention as one type of a liquid ejecting apparatus will be described with reference to FIGS. 1 to 3.

As shown in FIG. 1, a printer 11 according to this embodiment includes a record head 12 as a liquid ejecting head that ejects ink (liquid) onto a target (not shown) and an ink supplying device 14 as a liquid supplying device that supplies ink housed in the inside of an ink cartridge 13 as a liquid supplying source to the record head 12. In the ink supplying device 14, an ink flowing path (a liquid supplying flow path) 15 that supplies ink from the upstream side that is the ink cartridge 13 side toward the downstream side that is the record head 12 side in a state that the upstream end of the ink supplying device is connected to the ink cartridge 13 and the downstream end of the ink supplying device is connected to the record head 12 is provided.

In addition, in the printer 11, a plurality of the ink supplying devices 14 is disposed in correspondence with the number of colors (types) of ink used in the printer 11. However, the configurations of the ink supplying devices are the same. Thus, in FIG. 1, one ink supplying device 14 that supplies ink of one color is shown together with the record head 12 and one ink cartridge 13. Hereinafter, a case where ink is supplied from the ink cartridge 13 disposed on the upstream side toward the record head 12 disposed on the downstream side through the ink flowing path 15 of one ink supplying device 14 shown in FIG. 1 will be described as an example.

As shown in FIG. 1, in the record head 12, a plurality of (four in this embodiment) nozzles 16 corresponding to the number of the installed ink supplying devices 14 is formed as openings on a nozzle forming face 12a that faces a platen (not shown). Ink is configured to be supplied from the ink flowing path 15 of a corresponding ink supplying device 14 to each nozzle 16 through a valve unit 17. In other words, in the valve unit 17, a pressure chamber (not shown) that temporarily stores ink flowing from the ink flowing path 15 is disposed to be communicated with the nozzle 16. Inside the pressure chamber, when ink is ejected from the nozzle 16, an amount of ink corresponding to the amount of ink consumed by the ink ejection is configured to appropriately flow from the ink flowing path 15 in accordance with opening and closing operations of a flow path valve not shown in the figure.

In addition, in the printer 11, a maintenance unit 18 that performs a cleaning operation for the record head 12 so as to dissolve clogging or the like of the nozzle 16 of the record head 12 is disposed in a home position in which the record head 12 is located in a non-printing state. The maintenance unit 18 includes a cap 19 that can be brought into contact with the nozzle forming face 12a of the record head 12 so as to surround the nozzle 16, a suction pump 20 that is driven for sucking ink from the inside of the cap 19, and a waste liquid tank 21 to which the ink sucked from the inside of the cap 19 in accordance with driving of the suction pump 20 is discharged as waste ink. In the cleaning operation, the suction pump 20 is driven in a state that the cap 19 is moved from the state shown in FIG. 1 so as to be brought into contact with the nozzle forming face 12a of the record head 12, and accordingly, negative pressure is generated in an inner space of the cap 19. Accordingly, ink having increased viscosity, ink in which bubbles are mixed, or the like is sucked from the inside of the record head 12 and is discharged toward the waste liquid tank 21.

The ink cartridge 13 includes a case 22 having an approximate box shape, the inside of which is formed of an ink chamber 22a for housing ink. From a lower wall of the case 22, a tube part 23 that is communicated with the inside of the ink chamber 22a is formed to protrude downward, and in the front end of the tube part 23, an ink supply opening 24 through which ink can be derived is formed. When the ink cartridge 13 is connected to the ink supplying device 14, an ink supplying needle 25 that protrudes from the ink supplying device 14 so as to form the upstream end of the ink flowing path 15 is inserted into the ink supply opening 24. In addition, in the upper wall of the case 22, an air communication hole 26 that allows the inside of the ink chamber 22a in which ink is housed 22 to be communicated with the air is formed by perforating the upper wall, and accordingly, the air pressure is applied to the liquid surface of the ink housed in the ink chamber 22a.

Next, the configuration of the ink supplying device 14 will be described in detail.

As shown in FIG. 1, the ink supplying device 14 includes a first flow path forming member 27 made of a resin material that becomes a base, a second flow path forming member 28 made of a resin material that is installed on the first flow path forming member 27 in a laminated state, and a flexible member 29 that is formed of a rubber plate or the like inserted between both the flow path forming members 27 and 28 for installation and has flexibility. Here, in a plurality of spots (three spots in this embodiment) located on the top face of the first flow path forming member 27, concave parts 30, 31, and 32 each forming a circular shape in the plan view are formed. In other words, one concave part 31 and two concave parts 30 and 32 that have a volume smaller than that of the concave part 31 and have an approximately same volume are formed to be horizontally arranged in parallel in the order of the concave part 30, the concave part 31, and the concave part 32 from the right side to the left side in FIG. 1.

On the other hand, in a plurality of spots (three spots in this embodiment) disposed on the bottom face of the second flow path forming member 28 that is laminated on the first flow path forming member 27, concave parts 33, 34, and 35 each having a circular shape in the plan view which face the concave parts 30, 31, and 32 formed on the top face of the first flow path forming member 27 vertically are formed. In other words, one concave part 34 and two concave parts 33 and 35 that have a volume smaller than that of the concave part 34 and have an approximately same volume are formed to be horizontally arranged in parallel in the order of the concave part 33, the concave part 34, and the concave part 35 from the right side to the left side in FIG. 1.

In other words, the ink supplying device 14 allows employment of a laminated structure in which a plurality of plate-shaped constituent members are laminated by forming the concave parts 30 to 32 and the concave parts 33 and 35 on a same plane.

In addition, in the bottom part of the concave part 35 that is formed on the leftmost side of the second flow path forming member 28 in FIG. 1, an air communication hole 35a that is communicated with the air is formed.

The flexible member 29 is inserted between the first flow path forming member 27 and the second flow path forming member 28 such that a plurality of spots (three in this embodiment) of the flexible member 29 are interposed between the concave parts 30 to 32 of the first flow path forming member 27 and the concave parts 33 to 35 of the second flow path forming member 28 so as to vertically partition the concave parts. As a result, a part of the flexible member 29 interposed between the concave part 30 of the first flow path forming member 27 and the concave part 33 of the second flow path forming member 28 is configured to serve as a suction-side valve body 36 that can be displaced by being elastically deformed between both the concave parts 30 and 33.

Similarly, a part of the flexible member 29 interposed between the concave part 31 of the first flow path forming member 27 and the concave part 34 of the second flow path forming member 28 is configured to serve as a diaphragm 37 that can be displaced by being elastically deformed between both the concave parts 31 and 34. In addition, similarly, a part of the flexible member 29 interposed between the concave part 32 of the first flow path forming member 27 and the concave part 35 of the second flow path forming member 28 is configured to serve as a ejection-side valve body 38 that can be displaced by being elastically deformed between both the concave parts 32 and 35.

In terms of flexibly deformable areas of the suction-side valve body 36, the diaphragm 37, the ejection-side valve body 38, while the suction-side valve body 36 and the ejection-side valve body 38 have an almost same size, the diaphragm 37 has a size larger than that of the suction-side valve body 36 or the ejection-side valve body 38.

As shown in FIG. 1, in the first flow path forming member 27 and the second flow path forming member 28, a first flow path 15a that is communicated between the ink supplying needle 25 that protrudes from the top face of the second flow path forming member 28 and the concave part 30 of the first flow path forming member 27 is formed to configure a part of the ink flowing path 15 of the ink supplying device 14. Similarly, in the first flow path forming member 27, the second flow path forming member 28, and the flexible member 29, a second flow path 15b that is communicated between the concave part 33 of the second flow path forming member 28 and the concave part 31 of the first flow path forming member 27 is formed to configure a part of the ink flowing path 15 of the ink supplying device 14.

In addition, similarly, in the first flow path forming member 27, a third flow path 15c that is communicated between the concave parts 31 and 32 of the first flow path forming member 27 is formed to configure a part of the ink flowing path 15 of the ink supplying device 14. In addition, in a flow path opening end of the third flow path 15c that is opened to the inner bottom face of the concave part 32 on the downstream side, a ball valve 39 that only allows passage of ink from the upstream side that is the concave part 31 side to the downstream side that is the concave part 32 side is disposed in a state that the ball valve is biased by a basing member not shown in the figure commonly in the valve closing direction in which the third flow path 15c is closed.

In addition, in the first flow path forming member 27, the second flow path forming member 28, and the flexible member 29, a fourth flow path 15d that is communicated between the concave part 32 of the first flow path forming member 27 and the top face of the second flow path forming member 28 is formed so as to configure a part of the ink flowing path 15 of the ink supplying device 14. In addition, to a flow path opening end of the fourth flow path 15d that is opened to the top face of the second flow path forming member 28, one end (an upstream end) of an ink supplying tube 15e that configures a part of the ink flowing path 15 of the ink supplying device 14 is connected. In addition, the other end (a downstream end) of the ink supplying tube 15e is connected to the valve unit 17 disposed on the record head 12 side.

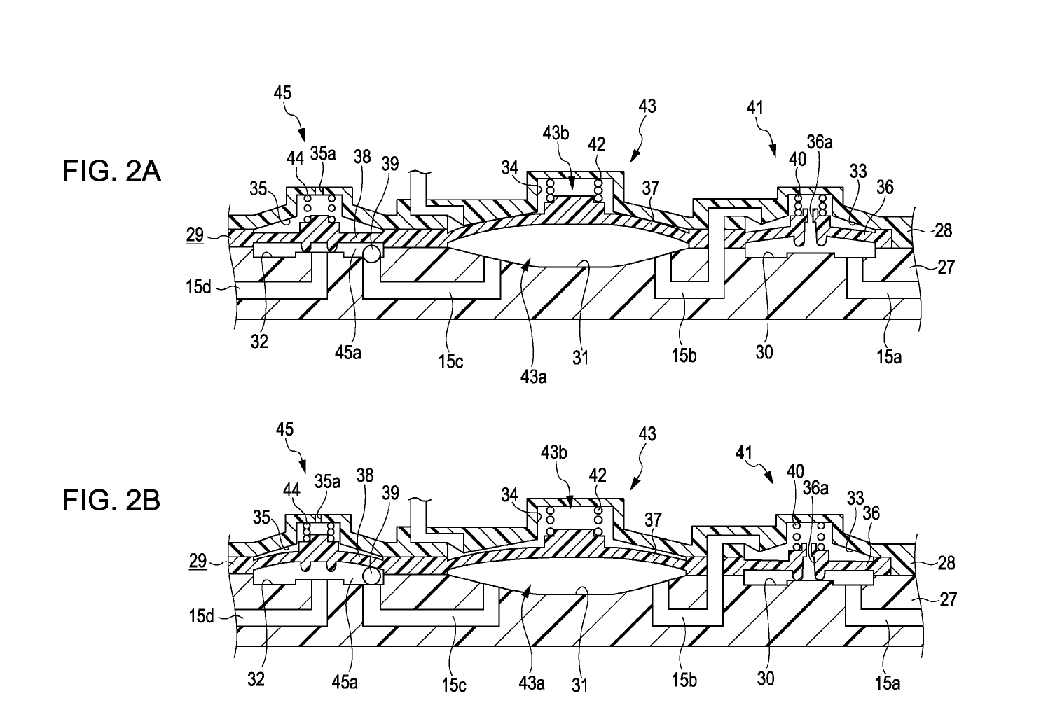

In addition, as shown in FIG. 1, a part that becomes the suction-side valve body 36 of the flexible member 29 of the ink supplying device 14 has a through hole 36a formed in the center thereof and is biased toward the inner bottom face of the concave part 30 disposed on the lower side by a biasing force of a coil spring 40 disposed inside the concave part 33 disposed on the upper side. Thus, the suction-side valve body 36 is located in the close-valve position in which the upstream end of the through hole 36a is brought into contact with the inner bottom face of the concave part 30. Then, when a force for resisting against the biasing force of the coil spring 40 is added to the suction-side valve body 36, the suction-side valve body 36 is moved to an open-valve position (see FIG. 2A) that is departed from the concave part 30.

As described above, when the suction-side valve body 36 is in the open-valve position, the suction-side valve body 36 approaches the inner bottom face of the concave part 33, and thus, the second flow path 15b is narrowed in the concave part 33. Accordingly, the suction-side valve body 36 serves as flow path resistance, and the flow velocity of the ink flowing from the first flow path 15a to the second flow path 15b decreases.

As a result, according to this embodiment, the suction-side valve 41 is configured by the concave parts 30 and 33, the suction-side valve body 36, and the coil spring 40 as a flow velocity reducing unit and a flow-path resistance changing unit that allows passage of ink only from the upstream side that is the ink cartridge 13 side to the downstream side on which ink is consumed by ink ejection of the record head 12.

In addition, a part that becomes the diaphragm 37 of the flexible member 29 of the ink supplying device 14 is biased toward the inner bottom face of the concave part 31 disposed on the lower side by a biasing force of a coil spring 42 disposed inside the concave part 34 disposed on the upper side. In this embodiment, a pulse-type pump 43 is configured by the concave parts 31 and 34, the diaphragm 37, the coil spring 42, and a space region having a changeable volume that is formed by being surrounded by the diaphragm 37 the concave part 31 disposed on the lower side is configured to serve as a pump chamber 43a (see FIGS. 2A and 2B) of the pump 43.

Similarly, a part that becomes the ejection-side valve body 38 of the flexible member 29 of the ink supplying device 14 is biased toward the inner bottom face of the concave part 32 disposed on the lower side by a biasing force of a coil spring 44 disposed inside the concave part 35 disposed on the upper side. In this embodiment, the ejection-side valve 45 storing ink in a pressure accumulating state is configured by the concave parts 32 and 35, the ejection-side valve body 38, and the coil spring 44. Thus, a space region having a changeable volume that is formed by being surrounded by the ejection-side valve body 38 and the concave part 32 disposed on the lower side configures a part of the ink flowing path 15 and is configured to serve as an pressure accumulating chamber 45a that can store ink in a accumulatively pressed state. The volume of the pressure accumulating chamber 45a is configured to be smaller than that of the pump chamber 43a, and the pressure accumulating chamber has almost the same size as that of the space region formed by being surrounded by the concave part 32 and the suction-side valve body 36. The biasing force of the coil spring 44 is operated in the direction for decreasing the volume of the pressure accumulating chamber 45a.

In addition, as shown in FIG. 1, to the concave part 34 of the second flow path forming member 28, a negative pressure generating device 47 formed of a suction pump or the like and an air opening mechanism 48 are connected through an air flowing path 46 divided in two branches. The negative pressure generating device 47 is driven so as to generate negative pressure by a driving force transferred through a one-way clutch not shown in the figure in a case where a driving motor 49 that can perform positive or negative rotation is driven for positive rotation. In addition, the negative pressure generating device is configured to be able to generate negative pressure inside the concave part 34 of the second flow path forming member 28 that is connected thereto through the air flow path 46. In this point, the space region having a changeable volume that is formed by being surrounded by the concave part 34 of the second flow path forming member 28 and the diaphragm 37 is configured to serve as a negative pressure chamber 43b that is in a negative-pressure state in accordance with driving of the negative pressure generating device 47.

In the air opening mechanism 48, an air opening valve 53 formed by additionally installing a sealing member 52 inside a box 51, in which an air opening hole 50 is formed, on the air opening hole 50 side is housed, and the air opening valve 53 is configured to be biased commonly by a biasing force of a coil spring 54 in the valve closing direction in which the air opening hole 50 is sealed. The air opening mechanism 48 is configured such that a cam mechanism 55, which is operated based on a driving force transferred through a one-way clutch not shown in the figure, is operated in a case where the driving motor 49 is driven for negative rotation, and the air opening valve 53 is displaced in the valve opening direction in resistance to the biasing force of the coil spring 54 by the operation of the cam mechanism 55. In other words, when the negative pressure chamber 43b that is connected to the air opening mechanism through the air flowing path 46 is in the negative pressure state, the air opening mechanism 48 is configured to dissolve the negative pressure by opening the inside of the negative pressure chamber 43b to the air by the valve opening operation of the air opening valve 53.

In FIG. 1, a configuration in which one negative pressure generating device 47, one air opening mechanism 48, and one driving motor 49 that drives those members are disposed for each of the plurality of the ink supplying devices 14 corresponding to ink colors is exemplified. However, a configuration described below may be used. The connection end side of the air flowing path 46 that is connected to the negative pressure chamber 43b of the pump 43 of the ink supplying device 14 may be branched in correspondence with the number of the plurality of installed ink supplying devices 14 corresponding to the ink colors, and each connection end of the branched air flowing path 46 may be connected to the negative pressure chamber 43b of the pump 43 of the corresponding ink supplying device 14. In such a case, by only disposing one negative pressure generating device 47, one air opening mechanism 48, and one driving motor 49 for the plurality of the ink supplying devices 14, the ink supplying devices 14 of the colors can be driven. Accordingly, miniaturization of the printer 11 can be implemented.

Next, the operation of the printer 11 configured as described above will be described below, with the operation of the ink supplying device 14 particularly focused on.

First, as a premise, the state shown in FIG. 1 is right after replacement of the ink cartridge and is assumed to be a state that all the suction-side valve body 36 of the suction-side valve 41, the diaphragm 37 of the pump 43, and the ejection-side valve body 38 of the ejection-side valve 45 are pressed by the inner bottom faces of the concave parts 30, 31, and 32 disposed on the lower side in accordance with the biasing forces of the coil springs 40, 42, and 44. In addition, the ball valve 39 that can open or close the third flow path 15c of the ink flowing path 15 of the ink supplying device 14 is in a state that the ball valve is biased to the valve closing position by a corresponding biasing member (not shown). In addition, the air opening valve 53 of the air opening mechanism 48 is in the close-valve state in which the air opening hole 50 is sealed by the air opening valve 53.

When the ink supplying device 14 supplies ink from the ink cartridge 13 side to the record head 12 side in the above-described state shown in FIG. 1, first, the driving motor 49 is driven for positive rotation so as to drive the pump 43. Then, the negative pressure generating device 47 generates negative pressure, and accordingly, the negative pressure chamber 43b of the ink supplying device 14 that is connected to the negative pressure generating device 47 through the air flowing path 46 is in a negative pressure state. Accordingly, the diaphragm 37 of the pump 43 is elastically deformed (displaced) to the negative pressure chamber 43b side in resistance to the biasing force of the coil spring 42, and thereby decreasing the volume of the negative pressure chamber 43b (see FIG. 2A). Then, to the contrary, the volume of the pump chamber 43a of the pump 43 that is partitioned from the negative pressure chamber 43b through the diaphragm 37 increases in accompaniment with the decrease in volume of the negative pressure chamber 43b.

In other words, the pump 43 displaces the diaphragm 37 in the direction in which the volume of the pump chamber 43a increases for suction driving. In particular, the diaphragm 37 is displaced from a position of the bottom dead center point shown in FIG. 1 to a position of the top dead center point shown in FIG. 2A. Accordingly, the inside of the pump chamber 43a is in the negative pressure state. The magnitude of the negative pressure generated in the pump chamber 43a changes in accordance with the speed of displacement of the diaphragm 37. In other words, when the diaphragm 37 is displaced rapidly from the position of the bottom dead center point to the position of the top dead center point and the volume of the pump chamber 43a increases rapidly, high negative pressure is generated, compared to a case where the volume of the pump chamber increases gently.

Then, the negative pressure generated by the pump 43 is applied to the concave part 33 of the suction-side valve 41 disposed on the upper side through the second flow path 15b. Thus, the suction-side valve body 36 is elastically deformed (displaced) to the upper side (that is, in the valve opening direction) in resistance to the biasing force of the coil spring 40 based on a pressure difference between the ink pressure of the inside of the concave part 30 disposed on the lower side and the pressure of the inside of the concave part 33 disposed on the upper side.

As a result, the suction-side valve body 36 approaches the inner bottom face of the concave part 33 and increases the flow path resistance of the second flow path 15b in the concave part 33 through which ink can be passed at a first speed, and the first flow path 15a and the second flow path 15b are communicated with each other through the through hole 36a of the suction-side valve body 36. Accordingly, ink is sucked into the inside of the pump chamber 43a in a state that the flow velocity is suppressed (a second flow velocity) from the inside of the ink cartridge 13 through the first flow path 15a, the concave part 30, the through hole 36a, the concave part 33, and the second flow path 15b.

The displacement amount of the suction-side valve body 36 is determined based on a pressure difference between the pressure of the second flow path 15b and the pressure of the first flow path 15a. In other words, when the diaphragm 37 is rapidly displaced so as to increase the negative pressure of the second flow path 15b, the displacement amount of the suction-side valve body 36 increases. Accordingly, the suction-side valve body 36 contracts the coil spring 40 and is displaced to the position of the top dead center position shown in FIG. 2A. On the other hand, when the diaphragm 37 is gently displaced, the suction-side valve body 36 is displaced such that the first flow path 15a and the second flow path 15b are connected to each other through the through hole 36a. Accordingly, the area of the cross-section of the second flow path 15b inside the concave part 33 decreases for a case where the diaphragm 37 is rapidly displaced, and the flow path resistance increases. In such a case, the response speed from start of displacement of the suction-side valve body 36 to completion of the displacement increases for a case where the change of the negative pressure of the second flow path 15b is large, compared to a case where the change of the negative pressure of the second flow path is small, and the flow path resistance increases rapidly.

When the pump 43 is driven for a suction operation, the negative pressure of the pump chamber 43a is applied to the downstream side of the ink flowing path 15 relative to the pump chamber 43a through the third flow path 15c, that is, the third flow path 15c. However, in the downstream end of the third flow path 15c, the ball valve 39 is biased in the valve closing direction, and the close-valve state is set not to be transferred to the open-valve state unless ink ejecting pressure of predetermined positive pressure (for example, pressure equal to or higher than 3 kpa) is applied to the ball valve 39 from the upstream side of the third flow path 15c by driving the pump 43 for an ejection operation. However, in such a case, negative pressure is applied to the ball valve 39, and accordingly, the close-valve state is maintained.

Then, next, in the state shown in FIG. 2A, the driving motor 49 is driven for negative rotation. Then, the air opening valve 53 performs a valve opening operation in resistance to the biasing force of the coil spring 54 by the operation of the cam mechanism 55 of the air opening mechanism 48 and opens the negative pressure chamber 43b that is in the negative pressure state to the air. Accordingly, the diaphragm 37 of the pump 43 is elastically deformed (displaced) to the lower side (that is, the inner bottom face side of the pump chamber 43a) in accordance with the biasing force of the coil spring 42 so as to increase the volume of the negative pressure chamber 43b (see FIG. 2B). Then, to the contrary, the volume of the pump chamber 43a of the pump 43 partitioned from the negative pressure chamber 43b through the diaphragm 37 decreases in accompaniment of the increase in the volume of the negative pressure chamber 43b.

In other words, the pump 43 displaces the diaphragm 37 is in the direction in which the volume of the pump chamber 43a decreases so as to be driven for an ejection operation. In particular, as shown in FIG. 2B, the diaphragm 37 is slightly displaced in the direction from the position of the top dead center to the position of the bottom dead center point so as to apply pressure to the ink sucked into the pump chamber 43a at predetermined pressure (for example, pressure of about 30 kpa). Accordingly, ink is ejected from the inside of the pump chamber 43a. Thus, the ejection pressure is applied to the concave part 33 of the suction-side valve 41 disposed on the upper side through the second flow path 15b on the upstream side of the pump chamber 43a and elastically deforms (displaces) the suction-side valve body 36 to the lower side (that is, in the valve closing direction) in cooperation with the biasing force of the coil spring 40. As a result, the first flow path 15a and the second flow path 15b are not communicated with each other by the valve closing operation of the suction-side valve body 36. Accordingly, suction of ink from the ink cartridge 13 into the pump chamber 43a through the suction-side valve 41 is stopped, and a counter flow of the ink ejected from the pump chamber 43a in accordance with driving the pump 43 for the ejection operation to the ink cartridge 13 side through the suction-side valve 41 is regulated.

When the pump 43 is driven for the ejection operation, the pressure (for example, the pressure of about 30 kpa) of the ink ejected from the pump chamber 43a is also applied to the downstream side of the ink flowing path 15 through the third flow path 15c. Accordingly, the ejection pressure of the pump 43 causes the ball valve 39 that is in the close-valve state to perform a valve opening operation, and thus the pressure accumulating chamber 45a that is formed by being surrounded by the ejection-side valve body 38 of the ejection-side valve 45 and the concave part 32 disposed on the lower side is communicated with the pump chamber 43a through the third flow path 15c. As a result, the ink from the inside of the pump chamber 43a is supplied to the inside of the pressure accumulating chamber 45a of the ejection-side valve 45 in a pressed state through the third flow path 15c.

Then, in the ejection-side valve 45, the ejection-side valve body 38 is elastically deformed (displaced) to the upper side (that is, in the valve opening direction) in resistance to the biasing force of the coil spring 44 by the pressure of the ink that is supplied in the pressed state to the inside of the pressure accumulating chamber 45a. As a result, as shown in FIG. 2B, the ink is stored in the pressed state inside the pressure accumulating chamber 45a. In relation thereto, the biasing force of the coil spring 44 of the ejection-side valve 45, for example, is set to about 13 kpa, so that the ejection-side valve body 38 can be elastically deformed upward by the pressure of the ink in a case where the ink flows into the inside the pressure accumulating chamber 45a with ejection pressure that can cause the ball valve 39 to perform a valve opening operation.

Thereafter, a state that the ejection pressure of the ink that is pressed by the diaphragm 37 and is ejected from the pump chamber 43a is balanced in the flow path regions (including the pump chamber 43a and the pressure accumulating chamber 45a) disposed on the downstream side of the ink flowing path 15 relative to the concave part 33 of the suction-side valve 41 disposed on the upper side is maintained. In other words, in the pressure accumulating chamber 45a, a state that the ejection-side valve body 38 is located in the position of the top dead center point is maintained, and an open-valve state in which the pressure accumulating chamber 45a and the fourth flow path 15d are communicated with each other is maintained.

Thereafter, when the ink is ejected from the record head 12 toward the target (not shown), ink of an amount corresponding to the amount of consumption of ink accompanied with the ink ejection is supplied from the inside of the ink flowing path 15 to the record head 12 side through the valve unit 17. Accordingly, in accordance with consumption of ink on the downstream side (the record head 12 side), ink of the corresponding amount is supplied from the pump chamber 43a to the downstream side that becomes the record head 12 side through the pressure accumulating chamber 45a in a pressed state based on the pressing force of the diaphragm 37 biased by the biasing force of the coil spring 42 in the direction in which the volume of the pump chamber 43a decreases.

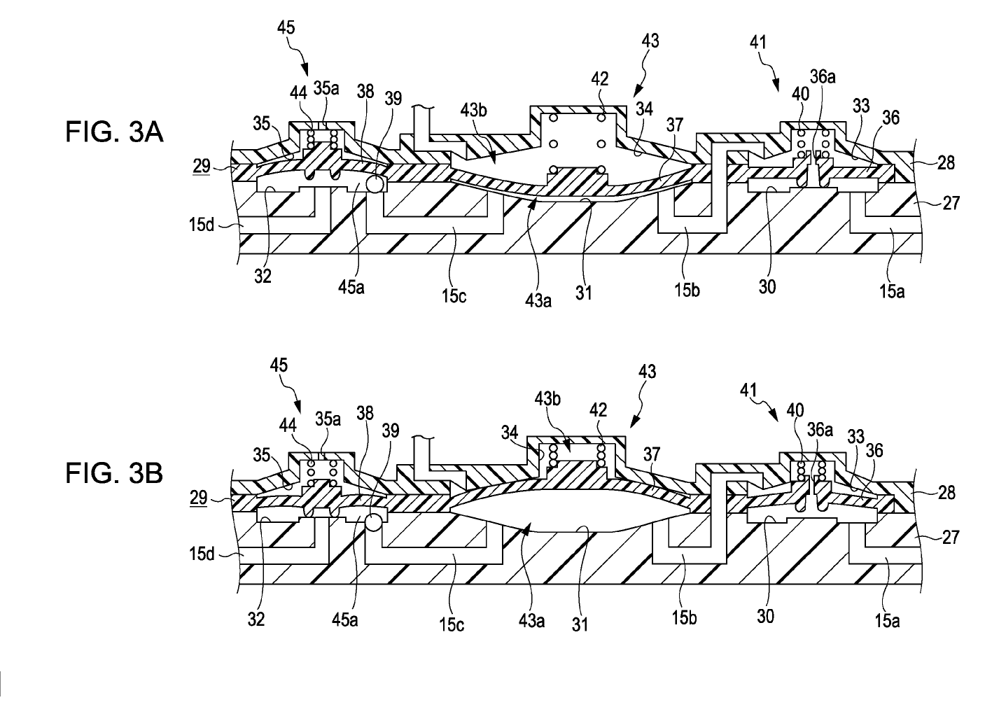

As a result, as shown in FIG. 3A, the volume of the inside of the pump chamber 43a gradually decreases, and finally, the diaphragm 37 is displaced near the position of the bottom dead center point. At this moment, inside the pump chamber 43a and the pressure accumulating chamber 45a, pressure of about 13 kpa is maintained in a balanced state. Accordingly, the ejection-side valve body 38 is located in the position of the top dead center point, and the volume of the pressure accumulating chamber 45a is maintained to be the maximum.

Then, the driving motor 49 is driven for positive rotation again, and the air opening valve 53 of the air opening mechanism 48 is displaced to the valve closing position in which the air opening hole 50 is closed. In addition, the negative pressure generating device 47 generates negative pressure, and the negative pressure chamber 43b is in a negative pressure state. Accordingly, the diaphragm 37 is elastically deformed (displaced) to the negative pressure chamber 43b side in resistance to the biasing force of the coil spring 42. In other words, the pump 43 starts to be driven for a suction operation again. As a result, as shown in FIG. 3B, the diaphragm 37 is displaced to the position of the top dead center point so as to increase the volume of the pump chamber 43a, and thus, the inside of the pump chamber 43a is in a negative pressure state. Accordingly, the suction-side valve body 36 is elastically deformed (displaced) in the valve opening direction by the operation of the negative pressure. Thus, the first flow path 15a and the second flow path 15b are communicated with each other through the through hole 36a of the suction-side valve body 36 in the state of the increased flow path resistance, and ink is sucked into the pump chamber 43a from the inside of the ink cartridge 13 in the state of the suppressed flow velocity, again.

On the other hand, in the pressure accumulating chamber 45a that is disposed on the downstream side of the pump chamber 43a, the pressure of the inside of the pump chamber 43a is lowered than that of the inside of the pressure accumulating chamber 45a, and accordingly, the ball valve 39 is displaced to the valve closing position. Accordingly, in the pressure accumulating chamber 45a, in accordance with pressing the ejection-side valve body 38 by using the coil spring 44, ink is continuously pressed to be supplied toward the record head 12 disposed on the downstream side through the fourth flow path 15d also during driving of the pump 43 for a suction operation. Thereafter, the pump 43 is driven for an ejection operation that is the same as described above, and the ink is pressed to be supplied to the record head 12 from the inside of the pump chamber 43a through the pressure accumulating chamber 45a that is disposed on the downstream side.

According to the ink supplying device 14 and the printer 11 of the first embodiment, the following advantages can be acquired.

When the pump 43 is driven for the suction operation, the pump chamber 43a changes in the direction for increasing the volume thereof, and accordingly, negative pressure is generated inside the ink flowing path 15 disposed on the upstream side of the pump chamber 43a. Accordingly, ink is sucked into the pump chamber 43a from the upstream side that becomes the ink cartridge side 13 through the ink flowing path 15. In such a case, when the speed of change of the volume of the pump chamber 43a is high, ink is sucked from the ink cartridge 13 through the inside of the ink flowing path 15 at a high flow velocity. However, since the suction-side valve 41 changes the flow path resistance of the ink flowing path 15 in accordance with the speed of change of the volume of the pump chamber 43a, the flow velocity of the ink decreases. In other words, when the flow velocity of the ink at a time when the ink is sucked into the ink flowing path 15 from the ink cartridge 13 is too high, the flow path resistance increases, and accordingly, the flow velocity of the ink is reduced such that infusion of air can be suppressed. On the other hand, when the speed of change of the volume of the pump chamber 43a is slow, the flow path resistance does not increases that much, and thus, the flow velocity is not reduced that much. Accordingly, infusion of air into the inside of the ink flowing path 15 for a case where the pump 43 is driven for a suction operation from the ink cartridge 13 can be suppressed, and the driving efficiency of the pump 43 can be maintained in an excellent state.

When the speed of change of the volume of the pump chamber 43a is high, the negative pressure applied to the second flow path 15b increases. Accordingly, the flow velocity of the ink is to increase originally as the magnitude of the negative pressure increases. In addition, the displacement amount of the suction-side valve body 36 is determined based on a pressure difference between the pressure of the second flow path 15b and the pressure of the first flow path 15a. In other words, as the negative pressure of the second flow path 15b increases, the displacement amount of the suction-side valve body 36 increases, and thereby the suction-side valve body 36 contracts the coil spring 40 so as to be displaced to the position of the top dead center point. At that moment, the response speed from start of the displacement of the suction-side valve body 36 to completion of the displacement becomes high for a case where the negative pressure of the second flow path 15b is high, compared to a case where the negative pressure of the second flow path is low, and thereby the flow path resistance increases in a speedy manner. Accordingly, a part of the negative pressure operated for increasing the flow velocity of the ink is offset by the flow path resistance operated for decreasing the speed, and thereby the higher the flow velocity of the ink is to be originally, the more rapidly the flow velocity decreases. Thus, for a case where the flow velocity of the ink sucked into the inside of the ink flow path 15 from the ink cartridge 13 is to be high originally, the flow velocity decreases rapidly by the suction-side valve 41. Therefore, infusion of air can be suppressed effectively.

On the other hand, when the volume of the pump chamber 43a increases gently, the change of the negative pressure in the second flow path 15b is gentle, compared to a case where the volume of the pump chamber rapidly increases. Accordingly, the suction-side valve body 36 is gently displaced to the open-valve position, and the ink is sucked into the pump chamber 43a side through the through hole 36a. However, the change of the cross-section area of the second flow path 15b in the concave part 33 which is accompanied by the displacement of the suction-side valve body 36 is small, and the response speed of changing the flow path resistance is low, and accordingly, the flow resistance of the ink flowing path 15 does not increase rapidly. Accordingly, inhibition of the flow of ink that flows at a slow speed by being drawn by small negative pressure can be suppressed.

When the suction-side valve body 36 of the suction-side valve 41 is displaced in the direction in which the flow path resistance of the ink flowing path 15 increases, the flow velocity of the ink can be reduced due to the increased flow path resistance in a simple manner.

When negative pressure is applied to the inside of the ink flowing path 15 disposed on the upstream side of the pump chamber 43a in accompaniment with the driving the pump 43 for the suction operation, the suction-side valve body 36 that is disposed inside the ink flowing path 15 and has flexibility is elastically deformed so as to narrow the inside of the ink flowing path 15, and thereby the flow path resistance increases. Accordingly, the flow path resistance can be changed in accordance with the speed of change of the volume of the pump chamber 43a by using a simple configuration without a complicated configuration.

When the pump 43 is driven for the suction operation, the suction-side valve body 36 serves as a one-way valve that allows passage of ink only from the upstream side to the downstream side. Accordingly, by additionally using the one-way valve as a constituent element of the suction-side valve 41, the number of parts can decrease. In addition, the counter flow of ink to the ink cartridge 13 side can be suppressed by using the suction-side valve body 36 in a case where the pump 43 is driven for the ejection operation.

### Second Embodiment

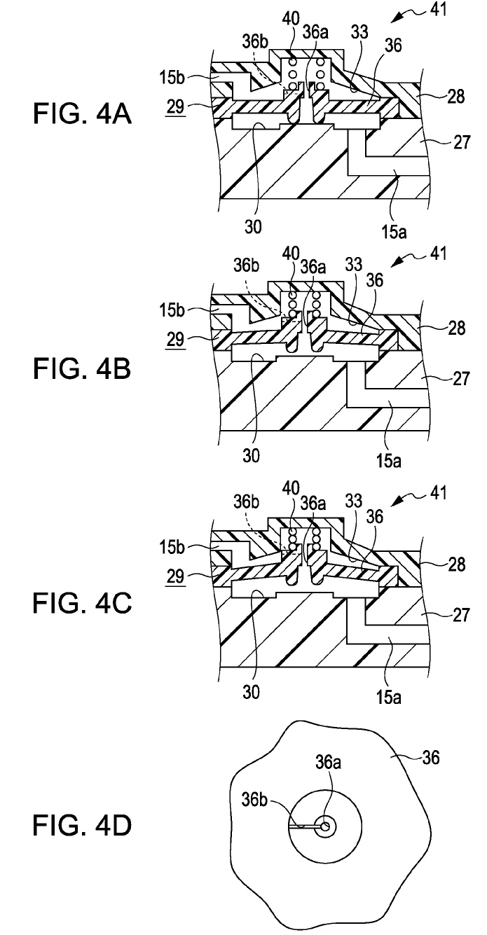

Next, a second embodiment of the invention will be described with reference to FIGS. 4A, 4B, 4C, and 4D. A difference between the configurations of the second embodiment and the first embodiment is the shape of the suction-side valve 41, and other configurations are common to the first and second embodiments. Thus, to each same configuration part, a same reference sign is assigned, and a detailed description thereof is omitted here.

As shown in FIGS. 4A, 4B, 4C, and 4D, the suction-side valve body 36 according to this embodiment is configured such that the through hole 36a forming a part of the ink flowing path 15 is in a closed state by bringing the opening part that becomes the downstream end of the through hole 36a into contact with the inner face of the concave part 33 in a case where the suction-side valve body 36 is located in the position of the top dead center point (see FIG. 4C). In addition, on a face of the outer face of the suction-side valve body 36 which is disposed on a side facing the inner face of the concave part 33, an ink flowing path groove 36b as a throttle forming part that has an upstream end connected to the through hole 36a and a downstream end connected to the second flow path 15b in a state in which the suction-side valve body 36 is located in the position of the top dead center point and is brought into contact with the inner face of the concave part 33 is formed. The cross-section area of the ink flowing path groove 36b is formed to be smaller than that of the through hole 36a.

When the negative pressure of the second flow path 15b is smaller than the biasing force of the coil spring 40, the suction-side valve 41 having the above-described configuration is in the close-valve state by bringing the suction-side valve body 36 into contact with the inner bottom face of the concave part 30.

Then, when the pump 43 is driven for the suction operation so as to increase the volume of the pump chamber 43a and the negative pressure of the second flow path 15b is larger than the biasing force of the coil spring 40, as shown in FIG. 4B, the suction-side valve body 36 is in the open-valve state. Thus, the suction-side valve body approaches the inner bottom face of the concave part 33 and narrows the cross-section area of the second flow path 15b in the concave part 33. Then, when the volume of the pump chamber 43a increases further, the suction-side valve body 36, as shown in FIG. 4C, is displaced to the position of the top dead center point in which the suction-side valve body is brought into contact with the inner bottom face of the concave part 33 and is in a state in which the ink flowing path 15 is closed.

However, even in such a case, passage of ink from the upstream side to the downstream side through the ink flowing path groove 36b that is formed on the top face of the suction-side valve body 36 is allowed. Accordingly, the first flow path 15a and the second flow path 15b are communicated with each other through the through hole 36a and the ink flowing path groove 36b, and the flow path resistance particularly in the ink flowing path groove 36b increases.

Accordingly, ink is sucked into the pump chamber 43a without any delay regardless of the magnitude of the negative pressure generated by the pump 43. Then, when the diaphragm 37 of the pump 43 is displaced near the position of the top dead center point, the pump is switched to be driven for the ejection operation. Accordingly, positive pressure is applied to the second flow path 15b, and again as shown in FIG. 4A, the suction-side valve 41 is in the close-valve state.

According to the second embodiment, in addition to the above-described advantages according to the first embodiment, the following advantages can be acquired.

The suction-side valve body 36 is displaced in the direction in which the ink flowing path 15 is closed, and accordingly, the flow velocity of ink flowing in the ink flowing path 15 in accompaniment with the displacement of the suction-side valve body 36 decreases. However, even when the displacement of the suction-side valve body 36 increases so as to close the ink flowing path 15, ink is moved slowly to the downstream side through the ink flowing path groove 36b, and accordingly, the ink can be supplied to the pump chamber 43a with infusion of air suppressed.

To the record head 12, ink with infusion of air therein suppressed is supplied by the ink supplying device 14. Accordingly, when ink is ejected from the record head 12, occurrence of ejection failure due to clogging or the like can be suppressed.

In addition, the above-described embodiments may be changed as follows.

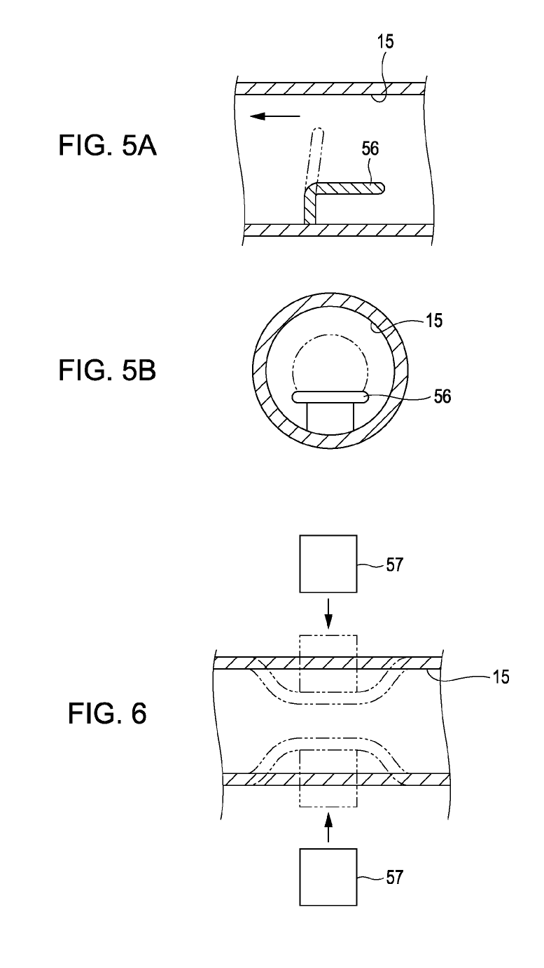

As shown in FIGS. 5A and 5B, as a flow velocity reducing unit and a flow path resistance changing unit, a tongue piece part 56 as a displacement member may be disposed in the ink flowing path 15 that is disposed on the upstream side of the pump 43 (first modified example). In other words, the tongue piece part 56 according to the first modified example is formed to protrude from the inner side of the ink flowing path 15 for forming a bent shape in which the front end of a small-disc-shaped elastic member having a cross-section area smaller than that of the ink flowing path 15 is fallen toward the upstream side. When the flow velocity of ink flowing in the ink flowing path 15 is low, as denoted by solid lines shown in FIGS. 5A and 5B, the front end side does not rise, and the tongue piece part 56 maintains the bent shape. On the other hand, when the flow velocity is high, as denoted by dashed-two dotted lines shown in FIGS. 5A and 5B, the front end side rises so as to decrease the cross-section area of the ink flowing path 15, and accordingly, the flow path resistance of the ink flowing path 15 increases.

In other words, the tongue piece part 56 is disposed in the ink flowing path 15 so as to receive a force in the direction for rising the tongue piece part from ink that passes the tongue piece part. However, when the flow velocity of the ink is low, the elasticity of the tongue piece part that maintains the bent shape is stronger than the force applied by the passing ink. Accordingly, the front end side of the tongue piece part 56 does not rise, and the flow path resistance of the ink flowing path 15 is small. On the other hand, when the flow velocity of the ink is high, a force applied by the passing ink is stronger than the elasticity of the tongue piece part that maintains the bent shape. Accordingly, the tongue piece part 56 rises, and the flow path resistance of the ink flowing path 15 increases. According to the first modified example, the flow path resistance can be increased in accordance with an increase of the flow velocity of the ink flowing in the ink flowing path 15.

As shown in FIG. 6, the cross-section of the ink flowing path 15 may be changed by forming the ink flowing path 15 with an ink tube that has flexibility and is elastically deformed or the like and pinching the ink flowing path 15 by using a pinching member as a displacement member 57 disposed outside the ink flowing path 15 (a second modified example). According to the second modified example, the flow path resistance can be changed without arranging a special configuration inside the ink flowing path 15.

In addition, the ink flowing path groove 36b may be formed in a part (that is, the inner face of the ink flowing path 15) of the second flow path forming member 28 side which is brought into contact with the top face of the suction-side valve body 36 in a case where the suction-side valve body 36 is displaced to the position of the top dead center point to be in a state in which the through hole 36a is closed. In addition, in the first modified example, in a case where the tongue piece part 56 having such a size that the tongue piece part can close the ink flowing path 15 is used, the ink flowing path groove 36b may be formed in a part of the edge of the tongue piece part 56 or a part of the inner face of the flow path forming member that configures the ink flowing path 15. In addition, in the above-described embodiments and the first and second modified examples, in a case where the suction-side valve body 36 is displaced to the position of the top dead center point so as to be in the state for closing the through hole 36a, in order to acquire clearance between the outer face of the suction-side valve body 36 and the inner face of the ink flowing path 15, a protrusion may be disposed on at least one between the outer face of the suction-side valve body 36 and the inner face of the ink flowing path 15 so as to acquire and form the ink flowing path groove 36b.

The suction-side valve 41 applies a biasing force used for biasing the suction-side valve body 36. As the suction-side valve, a biasing member of any other type such as a blade spring, a coil spring, or rubber may be used. By using the above-described biasing member, the biasing force applied to the suction-side valve body 36 can be maintained without additionally operating a device that maintains the biasing force. Similarly, the pump 43 and the pressure accumulating chamber 45a apply biasing forces used for biasing the diaphragm 37 and the ejection-side valve body 38. As the pump and the pressure accumulating chamber, biasing members of other types such as blade springs, coil springs, or rubber may be used. By using the above-described biasing member, the biasing forces applied to ink inside the pump chamber 43a and the pressure accumulating chamber 45a can be maintained regardless of the driving state of the negative pressure generating device 47.

In addition, a one-way valve that allows passage of ink only from the upstream side to the downstream side and a displacement member that changes the flow path resistance may be configured separately.

In addition, as the suction-side valve body 36, an electromagnetic valve may be used. In such a case, when the suction-side valve body 36 is controlled to open the valve in accordance with the change of the volume of the pump chamber 43a in an electromagnetic manner, the cross-section area of the flow path that is opened in accompaniment with opening the valve, and thereby the flow path resistance can change.

The ink supplying device 14 may be configured not to dispose the one-way valve that allows passage of ink only from the upstream side to the downstream side by setting the flow path resistance values to be different for the upstream side and the low stream side of the pump 43 or by adding a configuration for suppressing the counter flow of ink to the ink cartridge 13.

In addition, the flow path resistance may be changed by changing concavo-convex of the inside of the flow path or the direction of the flow. In addition, the flow resistance may be changed by selecting a flow path of a plurality of flow paths having different flow path resistance values for passing the ink in accordance with the flow velocity. In addition, the flow velocity may be changed by selecting a plurality of flow paths having the same flow path resistance.

In addition, the speed of change of the volume of the pump chamber 43a and the response speed that changes the flow path resistance may not be correlated to each other.

In addition, the displacement speed of the diaphragm 37 may be configured to be directly controlled by the flow velocity reducing unit.

In addition, as the pump 43, a piston pump in which the pump chamber 43a is directly pressed by a piston that can reciprocate inside the negative pressure chamber 43b and the volume of the pump chamber 43a is changed in accompaniment with the reciprocating movement. In addition, the change of the volume of the pump chamber may be, in a gear-type pump, a change of a part communicated with a suction opening of a pump which increases the volume in accompaniment with driving the pump.

In addition, as the driving source of the pump 43, a positive pressure generating device instead of the negative pressure generating device 47 may be used. As the coil spring 42 serving as a biasing member, an extension spring may be used instead of a compression spring. In addition, the compression spring as the coil spring 42 may be disposed not on the negative pressure chamber 43b side but on the pump chamber 43a side. In the above-described modified examples, when the pump 43 is driven for the suction operation, the diaphragm 37 is displaced so as to increase the volume of the pump chamber 43a by the biasing forces of the springs. On the other hand, when the pump 43 is driven for the ejection operation, compressed air is introduced from the positive pressure generating device to the concave part 34 (in the embodiments, the negative pressure chamber 43b) of the pump 43 which is disposed on the upper side.

In addition, instead of the negative pressure generating device 47 and the positive pressure generating device, a cam mechanism as a mechanism for displacing the diaphragm 37 may be used. In other words, for example, a base end part of a pulling member in which a locking part is formed is fixed to the diaphragm 37 pressed by the coil spring 42 of the compression spring. Then, by bringing the cam member into contact with the locking part of the pulling member, the diaphragm 37 may be displaced through the pulling member. In addition, when a tension spring is used, the base end part of the pressing member is fixed to the diaphragm 37, and the front end part may be configured to be pressed to the diaphragm 37 side by the cam member.

In descriptions here, the liquid includes liquids (inorganic solvent, organic solvent, liquid solution, liquid resin, liquid metal (metal melt), and the like) other than ink, a liquid body formed by dispersing or mixing particles of a function material into a liquid, and a fluid body such as gel. In addition, the liquid ejecting apparatus that ejects or discharges the above-described liquid, for example, may be a liquid body ejecting apparatus that ejects a liquid body including a material such as an electrode material or a coloring material (pixel material) used for producing a liquid crystal display, an EL (electroluminescence) display, a field emission display, or the like in a dispersed or dissolved form, a liquid ejecting apparatus that ejects a bioorganic material used for producing a bio chip, or a liquid ejecting apparatus that ejects a liquid that is used as a precision pipette and becomes a test material. In addition, the liquid ejecting apparatus may be a liquid ejecting apparatus that ejects a lubricant to a precision machine such as a clock or a camera in a pin-point manner, a liquid ejecting apparatus that ejects a transparent resin liquid such as an ultraviolet-curable resin onto a substrate for forming a tiny hemispherical lens (optical lens) used in an optical communication element or the like, a liquid ejecting apparatus that ejects an acid or alkali etching liquid for etching a substrate or the like, or a fluid ejecting device that ejects a fluid body such as gel (for example, physical gel).

In the above-described embodiment, although a liquid ejecting apparatus has been embodied as the ink jet printer 11, however, the liquid ejecting apparatus may be embodied as a liquid ejecting apparatus that ejects or discharges a liquid other than ink. In addition, the invention may be applied to various types of liquid ejecting apparatuses having a liquid ejecting head that ejects a small amount of liquid droplets or the like. Here, the liquid droplet represents the shape of the liquid ejected from the liquid ejecting apparatus and includes the shape of a particle, a tear, or a lengthy string. In addition, the liquid described here represents a material that the liquid ejecting apparatus can eject. For example, the liquid may be a material in the liquid phase and includes a liquid body having high or low viscosity, a material in the fluid phase such as sol, gel water, other inorganic solvent, organic solvent, liquid solution, liquid resin, or liquid metal (metal melt). In addition, the liquid includes not only a liquid as one phase of a material but also a material in which particles of a function material formed of a solid material such as a pigment or a metal particle is dissolved, dispersed, or mixed as a solvent. As major examples of the liquid, there are ink and liquid crystal described in the embodiment above. Here, the ink includes general water-based ink, oil-based ink, and various types of liquid compositions such as gel ink or hot-melt ink. As detailed examples of the liquid ejecting apparatus, there are a liquid ejecting apparatus that ejects a liquid body including a material such as an electrode material or a coloring material used for producing a liquid crystal display, an EL (electroluminescence) display, an field emission display, or the like in a dispersed or dissolved form, a liquid ejecting apparatus that ejects a bioorganic material used for producing a bio chip, a liquid ejecting apparatus that ejects a liquid that is used as a precision pipette and becomes a test material, a coloring apparatus, and a micro dispenser. In addition, the liquid ejecting apparatus may be a liquid ejecting apparatus that ejects a lubricant to a precision machine such as a clock or a camera in a pin-point manner, a liquid ejecting apparatus that ejects a transparent resin liquid such as an ultraviolet-curable resin onto a substrate for forming a tiny hemispherical lens (optical lens) used in an optical communication element or the like, or a liquid ejecting apparatus that ejects an acid or alkali etching liquid for etching a substrate or the like. The invention may be applied to any one type of the above-described liquid ejecting apparatuses.

What is claimed is:

1. A liquid supplying device comprising:
a liquid supplying flow path that supplies a liquid from an upstream side as a liquid supplying source side toward a downstream side on which the liquid is consumed;
a pump that is driven for changing the volume of a pump chamber that is a part of the liquid supplying flow path; and
a flow velocity reducing unit that reduces the flow velocity of the liquid passing through the liquid supplying flow path on the upstream side of the pump chamber by changing flow path resistance of the liquid supplying flow path in accordance with the speed of change of the volume of the pump chamber, in a case where the pump is driven for a suction operation that increases the volume of the pump chamber.

2. A liquid supplying device comprising:
a liquid supplying flow path that supplies a liquid from an upstream side as a liquid supplying source side toward a downstream side on which the liquid is consumed;
a pump that is driven for changing the volume of a pump chamber that is a part of the liquid supplying flow path; and
a flow velocity reducing unit that reduces the flow velocity of the liquid passing through the liquid supplying flow path to be a second flow velocity that is lower than a first flow velocity by changing flow path resistance of the liquid supplying flow path which is disposed on the upstream side of the pump chamber and the liquid can pass through at the first flow path in accordance with the speed of change of the volume of the pump chamber, in a case where the pump is driven for a suction operation that increases the volume of the pump chamber.

3. The liquid supplying device according to claim 1, wherein the flow velocity reducing unit has a high response speed of changing the flow path resistance of the liquid supplying flow path for a case where the speed of change of the volume of the pump chamber is high, compared to a case where the speed of change of the volume of the pump chamber is low.

4. The liquid supplying device according to claim 1, wherein the flow velocity reducing unit includes a displacement member that is displaced so as to change the flow path resistance of the liquid supplying flow path.

5. A liquid supplying device comprising:
a liquid supplying flow path that supplies a liquid from an upstream side as a liquid supplying source side toward a downstream side on which the liquid is consumed;
a pump that is driven for changing the volume of a pump chamber that is a part of the liquid supplying flow path; and
a flow resistance changing unit that changes flow path resistance of the liquid supplying flow path on the upstream side of the pump chamber in accordance with the speed of change of the volume of the pump chamber in a case where the pump is driven for a suction operation that increases the volume of the pump chamber.

6. The liquid supplying device according to claim 5, wherein the flow velocity of the liquid passing through the liquid supplying path of which the flow path resistance is changed by the flow path resistance changing unit is lower than that before the change of the flow path resistance by using the flow path resistance changing unit.

7. The liquid supplying device according to claim 5, wherein the flow path resistance changing unit has a relatively high response speed of changing the flow path resistance of the liquid supplying flow path for a case where the speed of change of the volume of the pump chamber is high, compared to a case where the speed of change of the volume of the pump chamber is low.

8. The liquid supplying device according to claim 5, wherein the flow path resistance changing unit includes a displacement member that is displaced so as to change the flow path resistance of the liquid supplying flow path.

9. The liquid supplying device according to claim 4, wherein the displacement member can be displaced to a position located on the upstream side of the pump chamber inside the liquid supplying flow path and is displaced so as to narrow the inside of the liquid supplying flow path in a case where negative pressure generated in accompaniment with driving the pump for the suction operation is received.

10. The liquid supplying device according to claim 9,
wherein the displace member is configured by a valve body that can be displaced between a close-valve position in which the liquid supplying flow path is closed and an open-valve position in which the liquid supplying flow path is opened, is normally biased toward the close-valve position side at a predetermined biasing force, and is displaced to the open-valve position side in resistance to the biasing force in a case where negative pressure generated in accompanied with driving the pump for the suction operation is received, and
wherein a through hole that allows passage of the liquid from the upstream side to the downstream side in a case where the valve body is displaced in the direction from the close-valve position to the open-valve position is formed in the valve body.

11. The liquid supplying device according to claim 4, wherein a throttle forming part that allows passage of the liquid between the upstream side and the downstream side of the displacement member in a case where the displacement member is displaced in the direction for increasing the flow path resistance of the liquid supplying flow path to be in a state in which the liquid supplying path is closed is disposed in at least one between an outer face of the displacement member and an inner face of the liquid supplying flow path.
